(19) United States
(12) Patent Application Publication
(10) Pub. No.: US 2026/0167531 A1
(43) Pub. Date: Jun. 18, 2026

(54) DECOUPLED FORWARD OSMOSIS WATER PROCESSOR AND METHODS THEREOF

(71) Applicant: Blue Origin, LLC, Kent, WA (US)

(72) Inventor: Gil Hurwitz, La Cañada Flintridge, CA (US)

(21) Appl. No.: 18/978,875

(22) Filed: Dec. 12, 2024

(51) Int. Cl. C02F 1/44

(52) U.S. Cl. CPC C02F 1/445; C02F 1/441; C02F 2201/007

(57) ABSTRACT

Wastewater purification systems and methods are provided. In one aspect, a system includes a break tank between a forward osmosis apparatus and a downstream purification apparatus, for the purification of wastewater. Such a break tank decouples the forward osmosis apparatus and the purification apparatus, and may enable variable operating modes (for example, processing in batch, semi-batch and/or continuous modes) of the purification system, thereby enabling energy and/or cost savings.

### BACKGROUND

### Technical Field

The present disclosure relates generally to water processing systems and methods, including but not limited to wastewater processing systems. More particularly, the present disclosure relates to decoupled forward osmosis and downstream purification apparatuses and methods.

### Description of the Related Technology

Combined forward osmosis (FO)/reverse osmosis (RO) systems for wastewater treatment are available. However, these systems typically couple the FO and RO subsystems to reduce overall system size and mass. For example, when forward osmosis is used for the processing of urine, a highly-concentrated and fouling-prone waste stream, a high salinity draw solution is recirculated on the back side of the membrane and pulls water from the urine until osmotic equilibrium is reached between the two solutions. The draw solution is typically composed of a simple salt which is then more easily processed by the RO system. This two-step, coupled approach extends the life of the RO membrane and improves recovered water quality. Forward osmosis is also used in a variety of other contexts, in addition to wastewater treatment. In additional examples, forward osmosis may be used in agricultural applications for the recovery of nutrients from runoff, and pharmaceutical applications to purify and/or dewater product streams.

FIG. 1 is a schematic illustration of an example coupled FO/RO system 100. The FO/RO system 100 includes a forward osmosis apparatus 104 and a reverse osmosis apparatus 110. In the coupled FO/RO system 100, a wastewater feed source 102 is provided to the forward osmosis apparatus 104 to form a processed draw solution 106 and a byproduct 108. The forward osmosis apparatus 104 and the reverse osmosis apparatus 110 are directly coupled such that the processed draw solution 106 is fed directly to the reverse osmosis apparatus 110 to form a product 112 and a recycled draw solution 114. The recycled draw solution 114 is then fed directly back into the forward osmosis apparatus 104.

Maximizing recoverable water from wastewater has been an objective of many Environmental Control and Life Support (ECLS) water systems, especially those aboard long-duration missions where make-up water resupply can be very costly. The National Aeronautics and Space Administration (NASA) has studied coupled FO/RO processes for urine treatment and found water recovery limited to about 87 wt. %, which is a similar water recovery to the distillation assembly aboard the International Space Station (ISS). Such limits to the water recover of FO/RO systems is in part due to the precipitation and scaling of sparingly soluble salts, such as calcium sulfate. Such salt scaling is also a major limiting factor for many municipal and industrial desalination processes.

### SUMMARY

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing systems and methods for purifying a water feed, such as a wastewater feed.

In one aspect, a wastewater purification system is provided. The wastewater purification system includes a forward osmosis apparatus configured to receive a wastewater feed source and form a processed draw solution and a byproduct solution, a break tank in fluid communication with and configured to receive the processed draw solution from the forward osmosis apparatus, and a purification apparatus in fluid communication with and configured to receive the processed draw solution from the break tank and form a product solution and a return solution.

In some embodiments, the forward osmosis apparatus is configured to operate at a first processing rate and the purification apparatus is configured to operate at a second processing rate, wherein the first processing rate is greater than the second processing rate.

In some embodiments, the forward osmosis apparatus is configured to form a supersaturated byproduct solution.

In some embodiments, the further includes a byproduct processing apparatus configured to receive the byproduct solution and form a processed byproduct and a byproduct solute.

In some embodiments, the byproduct processing apparatus is configured to form the processed byproduct and the byproduct solute within an induction time of the byproduct solution.

In some embodiments, the purification apparatus is a reverse osmosis purification apparatus.

In some embodiments, the forward osmosis apparatus is configured to receive the return solution from the purification apparatus.

In some embodiments, the system further includes a wastewater holding tank configured to provide the wastewater feed source to the forward osmosis apparatus.

In another aspect, a method of purifying wastewater is provided. The method includes, performing forward osmosis on a wastewater feed source to form a processed draw solution and a byproduct solution, storing the processed draw solution to form a stored draw solution, and performing purification on the stored draw solution to form a product solution.

In some embodiments, the byproduct solution is a supersaturated byproduct including a supersaturated solute.

In some embodiments, the method further includes processing the supersaturated byproduct to form a processed byproduct and a byproduct solute.

In some embodiments, the byproduct solute includes a salt selected from the group consisting of calcium sulfate, calcium phosphate, magnesium sulfate, magnesium phosphate, calcium carbonate, magnesium carbonate, ammonium nitrate, and combinations thereof.

In some embodiments, processing the supersaturated byproduct occurs within an induction time of the supersaturated byproduct.

In some embodiments, purification further includes forming a recycled draw solution.

In some embodiments, performing forward osmosis includes extracting water from the wastewater feed source into a draw solution, and wherein the draw solution includes the recycled draw solution.

In some embodiments, purification includes performing reverse osmosis.

In some embodiments, the stored draw solution is stored for at least 0.5 hours.

In some embodiments, forward osmosis is performed in at most 2 hours.

In some embodiments, purification is performed in at least 5 hours.

In some embodiments, the method is performed batchwise.

In some embodiments, forward osmosis is performed batchwise.

In some embodiments, purification is performed continuously.

In some embodiments, performing forward osmosis is stopped prior to performing purification.

In some embodiments, performing forward osmosis occurs at a first processing rate and performing purification occurs at a second processing rate, wherein the first processing rate is greater than the second processing rate.

In some embodiments, the ratio of the first processing rate to the second processing rate is at least about 5:1.

In some embodiments, the product solution includes water.

In some embodiments, the wastewater feed source includes urine.

In some embodiments, the method includes a water recovery of at least about 90 wt. %.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise. Furthermore, the figures are not necessarily drawn to scale.

FIG. 1 is a schematic illustration of an example coupled FO/RO system.

FIG. 2 is a schematic illustration of an example wastewater purification system including a break tank according to an embodiment of the present disclosure.

FIG. 3 is a schematic illustration of an example wastewater purification system including a byproduct processing apparatus according to an embodiment of the present disclosure.

FIG. 4 is a schematic illustration of an example FO/RO wastewater purification system including a break tank according to another embodiment of the present disclosure.

FIG. 5 is a schematic illustration of another example FO/RO wastewater purification system including a break tank according to an embodiment of the present disclosure.

FIG. 6 is a flow chart of an example method of purifying a wastewater feed including storing a processed draw solution according to an embodiment of the present disclosure.

FIG. 7 is a flow chart of an example method of purifying a wastewater feed including processing a supersaturated byproduct according to an embodiment of the present disclosure.

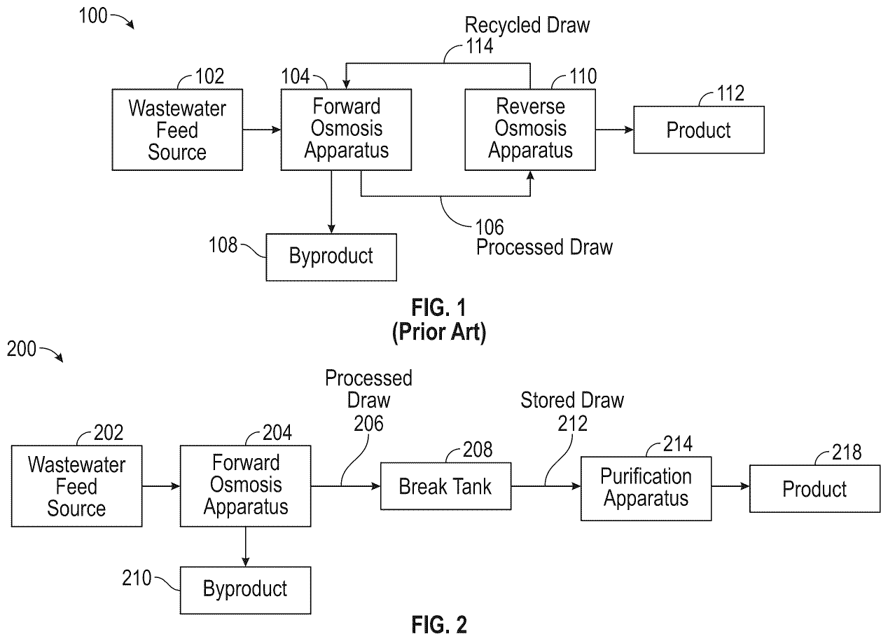

### DETAILED DESCRIPTION

Embodiments of the present disclosure relate to wastewater purification systems and methods including a break tank between a forward osmosis apparatus and a downstream purification apparatus, for the purification of wastewater. Such a break tank decouples the forward osmosis apparatus and the purification apparatus, and may enable variable operating modes (for example, processing in batch, semi-batch and/or continuous modes) of the purification system, thereby enabling energy and/or cost savings.

Furthermore, the break tank in systems and methods according to the present disclosure may enable the forward osmosis process to be performed relatively quickly in order to form a supersaturated byproduct solution, which can be advantageously processed prior to or prior to substantial precipitation of solutes. As the downstream purification system may operate at a slower rate relative to the forward osmosis apparatus, decoupling the systems can ensure the throughput of the forward osmosis apparatus is not limited by the purification apparatus. Therefore, the forward osmosis apparatus can process the wastewater feed at a faster rate in implementations of the present disclosure. Faster wastewater (for example, urine) processing time in the forward osmosis apparatus may allow for achieving water recoveries at or beyond supersaturation and improve the rejection of dissolved salts and organics (resulting in, improved recovered water purity). Faster wastewater processing times can also allow for operation at or above supersaturation levels of salts (for example, calcium sulfate) as long as the overall processing time is less than the time needed for crystallization and precipitation of the salt (also known as “induction time”). Processing of such a supersaturated solution improves efficiencies and allows for a streamlined system relative to systems and methods that allow for the precipitation of solutes. As such, by allowing for faster wastewater processing times, embodiments of the present disclosure can achieve higher water recoveries relative to conventional processes.

Systems and processes according to the present disclosure may be beneficial for use in a crewed space stations or spacecrafts for the processing and recovery of water from wastewater, which require improved efficiencies with regard to energy, volume, weight, and complexity. In addition, systems and processes according to the present disclosure may be utilized for elevated water recovery in many other environments or applications, such as for the re-use of aggressive wastewaters such as grey and black water in green building designs. Furthermore, systems and processes according to the present disclosure may be utilized for processing many different types of water or liquid streams, such as in agricultural applications for the recovery of nutrients from runoff and/or pharmaceutical (such as biopharmaceutical) applications to purify and/or dewater product streams.

### Decoupled Wastewater Purification Systems

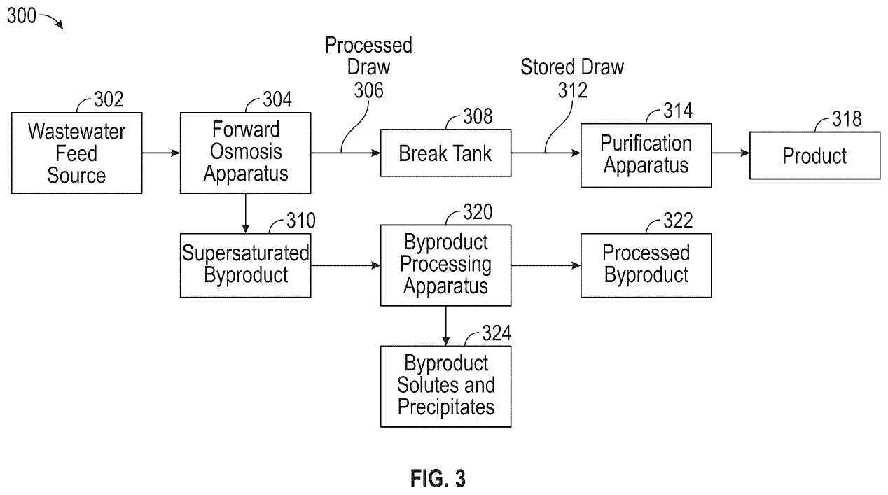

Decoupled wastewater purification systems utilizing a break tank are described herein. FIG. 2 is a schematic illustration of an example wastewater purification system including a break tank according to an embodiment of the present disclosure. The wastewater purification system 200 includes a break tank 208 that decouples a forward osmosis apparatus 204 and a purification apparatus 214 according to embodiments of the present disclosure. The wastewater purification system 200 can include features or methods that are substantially similar to features and methods described herein, for example such as those described in FIGS. 3-7 and descriptions thereof.

In the wastewater purification system 200, a forward osmosis apparatus 204 is configured to receive a wastewater feed from a source 202. The forward osmosis apparatus 204 is configured to process the wastewater feed to form a processed draw solution 206 and a byproduct 210. In some embodiments, the forward osmosis apparatus is configured to process the wastewater feed in, in about, in at most, or in at most about 2 hours. A break tank 208 is in fluid communication with the forward osmosis apparatus 204. The break tank 208 is configured to receive and store the processed draw solution 206 received from the forward osmosis apparatus 204. In some embodiments, the break tank 208 is configured to store the processed draw solution for, for about, for at least, or for at least about, 0.5 hours. A purification apparatus 214 is in fluid communication with the break tank 208. In some embodiments, the purification apparatus is a reverse osmosis apparatus. The purification apparatus 214 is configured to receive and process the stored draw solution 212 from the break tank 208 to form a product 218. In some embodiments, the purification apparatus 214 is configured to process the stored draw solution in, in about, in at least, or in at least about, 5 hours. The purification apparatus 214 may optionally produce a purification byproduct. For example, a reverse osmosis purification apparatus may produce a reverse osmosis byproduct in addition to producing the product 218.

Wastewater purification systems including a break tank, such as wastewater purification system 200 of FIG. 2, decouple the forward osmosis apparatus and the purification apparatus, enabling variable operating modes and energy and/or cost savings. Furthermore, such wastewater purification systems including a break tank may enable the forward osmosis process to be performed relatively quickly, and as the downstream purification system may operate at a slower rate relative to the forward osmosis apparatus, decoupling the systems can ensure the throughput of the forward osmosis apparatus is not limited by the purification apparatus. Therefore, such wastewater purification systems can process the wastewater feed at a faster rate, achieve water recoveries at or beyond supersaturation, improve the rejection of dissolved salts and organics (resulting in, improved recovered water purity), and/or achieve higher water recoveries relative to conventional processes. For example, in some embodiments, such wastewater purification systems may result in water recovery rates of, of about, of at least, or of at least about 90%, which is about 3% higher than rates reported by NASA for current wastewater purification systems.

FIG. 3 is a schematic illustration of an example wastewater purification system including a byproduct processing apparatus according to an embodiment of the present disclosure. The wastewater purification system 300 includes a byproduct processing apparatus 320 according to embodiments of the present disclosure. The wastewater purification system 300 can include features or methods that are substantially similar to features and methods described herein, for example such as those described in FIGS. 2 and 4-7 and descriptions thereof.

In the wastewater purification system 300, a forward osmosis apparatus 304 is configured to receive a wastewater feed from a source 302. The forward osmosis apparatus 304 is configured to process the wastewater feed to form a processed draw solution 306 and a supersaturated byproduct solution 310. In some embodiments, the forward osmosis apparatus is configured to process the wastewater feed in, in about, in at most, or in at most about 2 hours. A break tank 308 is in fluid communication with the forward osmosis apparatus 304. The break tank 308 is configured to receive and store the processed draw solution 306 received from the forward osmosis apparatus 304. In some embodiments, the break tank 308 is configured to store the processed draw solution for, for about, for at least, or for at least about, 0.5 hours. A purification apparatus 314 is in fluid communication with the break tank 308. In some embodiments, the purification apparatus 314 is a reverse osmosis apparatus. The purification apparatus 314 is configured to receive and process the stored draw solution 312 from the break tank 308 to form a product 318. In some embodiments, the purification apparatus is configured to process the stored draw solution in, in about, in at least, or in at least about, 5 hours. The purification apparatus 314 may optionally produce a purification byproduct. For example, a reverse osmosis purification apparatus may produce a reverse osmosis byproduct in addition to producing the product 318. A byproduct processing apparatus 320 is configured to receive and process the supersaturated byproduct solution 310 to form a processed byproduct 322 and byproduct solutes and precipitates 324. It will be understood that the term “byproduct solutes and precipitates” is intended to describe one potential scenario and does not exclude a scenario in which the byproduct processing apparatus 320 is configured to receive and process the supersaturated byproduct solution 310 to form a processed byproduct 322 and byproduct solutes that do not include precipitates. For example, in some embodiments, the byproduct solutes and precipitates 324 include or substantially include only solutes. In some embodiments, the byproduct solutes and precipitates 324 do not or do not substantially include precipitates.

Wastewater purification system including a break tank and forming a supersaturated byproduct that is processed by a byproduct processing apparatus, such as the wastewater purification system 300 of FIG. 3, may enable the forward osmosis process to be performed relatively quickly in order to form a supersaturated byproduct solution, which can be advantageously processed prior to or prior to substantial precipitation of solutes. As the downstream purification system may operate at a slower rate relative to the forward osmosis apparatus, decoupling the systems can ensure the throughput of the forward osmosis apparatus is not limited by the purification apparatus. Therefore, the forward osmosis apparatus can process the wastewater feed at a faster rate thereby allowing for the formation of supersaturated solutions. Faster wastewater processing time in the forward osmosis apparatus may allow for achieving water recoveries at or beyond supersaturation and improve the rejection of dissolved salts and organics. In addition, processing of such supersaturated solutions improves efficiencies and allows for a streamlined system relative to systems and methods that allow for the precipitation of solutes. As such, by allowing for faster wastewater processing times, embodiments of the present disclosure can achieve higher water recoveries relative to conventional processes. For example, in some embodiments, such wastewater purification systems may result in water recovery rates of, of about, of at least, or of at least about 90%, which is about 3% higher than rates reported by NASA for current wastewater purification systems.

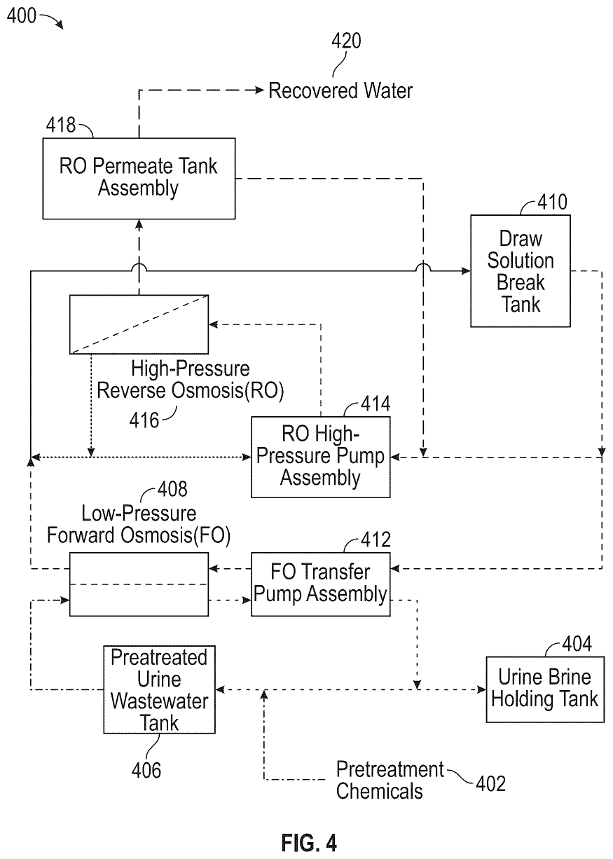

FIG. 4 is a schematic illustration of an example FO/RO wastewater purification system including a break tank according to another embodiment of the present disclosure. The FO/RO wastewater purification system 400 includes a draw solution break tank 410 according to embodiments of the present disclosure. The FO/RO wastewater purification system 400 can include features or methods that are substantially similar to features and methods described herein, for example such as those described in FIGS. 2, 3 and 5-7 and descriptions thereof. Features of the system 400 will be described with reference to treating urine, but it will be understood that embodiments of the system 400 can treat many other types of wastewater, such as but not limited to grey and black water.

In the FO/RO wastewater purification system 400, a pretreated urine wastewater tank 406 is configured to receive pretreatment chemicals 402. The pretreated urine wastewater tank 406 is in fluid communication with a urine brine holding tank 404. The pretreated urine wastewater tank 406 is configured to receive urine brine from the urine brine holding tank 404. A low-pressure forward osmosis (FO) apparatus 408 is in fluid communication with the pretreated urine wastewater tank 406. The low-pressure FO apparatus 408 is configured to receive pretreated urine wastewater from the pretreated urine wastewater tank 406.

The low-pressure FO apparatus 408 is in fluid communication with a draw solution break tank 410. The low-pressure FO apparatus 408 is configured to provide a processed draw solution to the draw solution break tank 410. The low-pressure FO apparatus 408 is also in fluid communication with a forward osmosis (FO) transfer pump assembly 412. The low-pressure FO apparatus 408 is configured to provide a byproduct solution to the FO transfer pump assembly 412. The byproduct solution may be a concentrated urine solution and/or a urine brine solution. In some embodiments, the byproduct solution is a supersaturated byproduct solution.

The draw solution break tank 410 is configured to store the processed draw solution received from the low-pressure FO apparatus 408 and a reverse osmosis (RO) byproduct solution from a high-pressure reverse osmosis (RO) apparatus 416. The draw solution break tank 410 is in fluid communication with a high-pressure RO pump assembly 414. The draw solution break tank 410 is also in fluid communication with the FO transfer pump assembly 412. The draw solution break tank 410 is configured to provide the stored draw solution to the high-pressure RO pump assembly 414 and the FO transfer pump assembly 412. The FO transfer pump assembly 412 is in fluid communication with the low-pressure FO apparatus 408. The FO transfer pump assembly 412 is configured to provide the stored draw solution to the low-pressure FO apparatus 408. The FO transfer pump assembly 412 is in fluid communication with the urine brine holding tank 404. The FO transfer pump 412 is configured to provide the byproduct solution to the urine brine holding tank 404 and the pretreated urine wastewater tank 406.

The high-pressure RO pump assembly 414 is in fluid communication with the high-pressure RO apparatus 416. The high-pressure RO pump assembly 414 is configured to provide the stored draw solution to a high-pressure reverse osmosis (RO) apparatus 416. The high-pressure RO apparatus 416 is in fluid communication with an RO permeate tank assembly 418. The high-pressure RO apparatus 416 is configured to provide a recovered water product, such as permeate, to the RO permeate tank assembly 418. The high-pressure RO apparatus 416 is in fluid communication with the draw solution break tank 410 and the high-pressure RO pump assembly 414. The high-pressure RO apparatus 416 is configured to provide a recycled draw solution to the draw solution break tank 410 and the high-pressure RO pump assembly 414. The RO permeate tank assembly 418 is in fluid communication with the high-pressure RO pump assembly 414 and/or provide recovered water 420 elsewhere. For example, the recovered water 420 can be provided as potable or environmental water to crew of a space vehicle or a space station, or used for other purposes in a space vehicle or a space station.

FO/RO wastewater purification systems including a break tank, such as FO/RO wastewater purification system 400 of FIG. 4, decouple the forward osmosis apparatus and the purification apparatus, enabling variable operating modes and energy and/or cost savings. Furthermore, such wastewater purification systems including a break tank may enable the forward osmosis process to be performed relatively quickly, and as the downstream reverse osmosis system may operate at a slower rate relative to the forward osmosis apparatus. Decoupling the systems can ensure the throughput of the forward osmosis apparatus is not limited by the purification apparatus. Therefore, such FO/RO wastewater purification systems can process the urine wastewater feed at a faster rate, achieve water recoveries at or beyond supersaturation, improve the rejection of dissolved salts and organics (resulting in, improved recovered water purity), and/or achieve higher water recoveries relative to conventional processes. For example, in some embodiments, such wastewater purification systems may result in water recovery rates of, of about, of at least, or of at least about 90%, which is about 3% higher than rates reported by NASA for current wastewater purification systems.

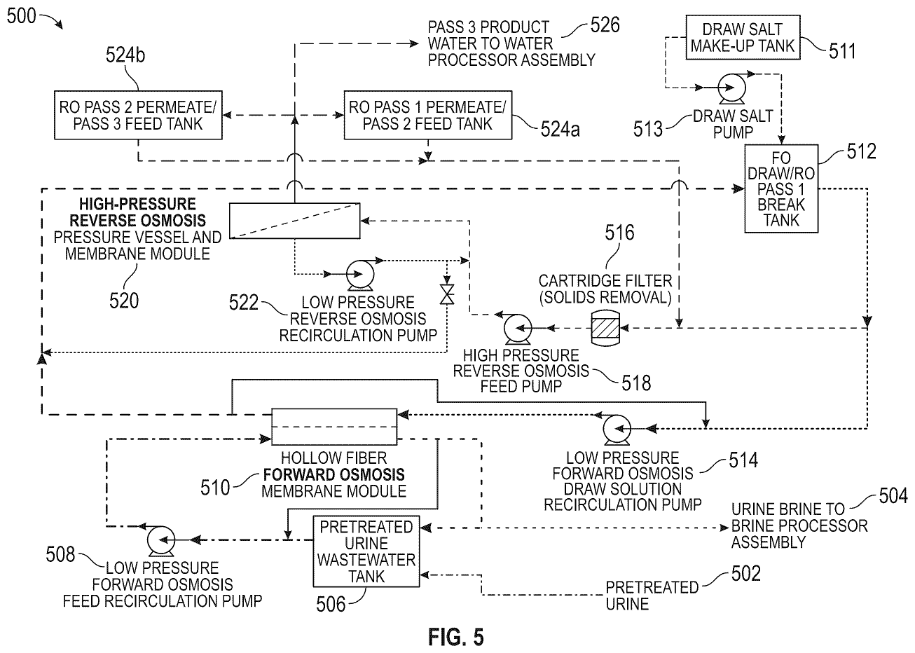

FIG. 5 is a schematic illustration of another example FO/RO wastewater purification system including a break tank according to an embodiment of the present disclosure. The FO/RO wastewater purification system 500 includes an FO draw solution and RO Pass 1 break tank 512 according to an embodiment of the present disclosure. The FO/RO wastewater purification system 500 can include features or methods that are substantially similar to features and methods described herein, for example such as those described in FIGS. 2-4, 6 and 7 and descriptions thereof. Features of the system 500 will be described with reference to treating urine, but it will be understood that embodiments of the system 500 can treat many other types of wastewater, such as but not limited to grey and black water.

In the FO/RO wastewater purification system 500, a pretreated urine wastewater tank 506 is configured to receive pretreated urine 502. The pretreated urine wastewater tank 506 is configured to receive urine brine. The pretreated urine wastewater tank 506 is in fluid communication with a urine brine to brine processor assembly 504. A hollow fiber forward osmosis (FO) membrane module 510 is in fluid communication the pretreated urine wastewater tank 506. The hollow fiber forward osmosis (FO) membrane module 510 is configured to receive pretreated urine wastewater from the pretreated urine wastewater tank 506 through a low pressure FO feed recirculating pump 508. The hollow fiber FO membrane module 510 is in fluid communication with the FO draw solution and RO pass 1 break tank 512. The hollow fiber FO membrane module 510 is configured to provide a processed FO draw solution (for example, spent/diluted draw solution) to the FO draw solution and RO pass 1 break tank 512. The hollow fiber FO membrane module 510 is in fluid communication with a low pressure forward osmosis draw solution recirculation pump 514. The hollow fiber FO membrane module 510 is configured to provide a processed FO draw solution (for example, spent/diluted draw solution) to the low pressure forward osmosis draw solution recirculation pump 514. The hollow fiber FO membrane module 510 is in fluid communication with the urine brine to brine processor assembly 504. The hollow fiber FO membrane module 510 is configured to provide a byproduct solution to the urine brine to brine processor assembly 504. The hollow fiber FO membrane module 510 is in fluid communication with the pretreated urine wastewater tank 506. The hollow fiber FO membrane module 510 is configured to provide a byproduct solution to the pretreated urine wastewater tank 506. The hollow fiber FO membrane module 510 is in fluid communication with the low pressure FO feed recirculating pump 508. The hollow fiber FO membrane module 510 is configured to provide a byproduct solution to the low pressure FO feed recirculating pump 508.

A draw salt make-up tank 511 is in fluid communication with the FO draw solution and RO pass 1 break tank 512. The draw salt make-up tank 511 is configured to provide make-up draw salts to the FO draw solution and RO pass 1 break tank 512 through a draw salt pump 513. The FO draw solution and RO pass 1 break tank 512 is in fluid communication with the low pressure forward osmosis draw solution recirculation pump 514. The FO draw solution and RO pass 1 break tank 512 is configured to provide the stored draw solution to the low pressure forward osmosis draw solution recirculation pump 514. The FO draw solution and RO pass 1 break tank 512 is in fluid communication with a high-pressure reverse osmosis (RO) pressure vessel and membrane module 520. The FO draw solution and RO pass 1 break tank 512 is configured to provide the stored draw solution to the high-pressure reverse osmosis (RO) pressure vessel and membrane module 520 through a cartridge filter 516 (for example, for the removal of solids) and a high pressure reverse osmosis feed pump 518.

The high-pressure RO pressure vessel and membrane module 520 is configured to circulate a solution back to itself. The high-pressure RO pressure vessel and membrane module 520 is configured to provide a concentrated draw solution to itself through the low pressure reverse osmosis recirculation pump 522. The high-pressure RO pressure vessel and membrane module 520 is in fluid communication with the FO draw solution and RO pass 1 break tank 512. The high-pressure RO pressure vessel and membrane module 520 is configured to provide a concentrated draw solution to the FO draw solution and RO pass 1 break tank 512 through the low pressure reverse osmosis recirculation pump 522. The high-pressure RO pressure vessel and membrane module 520 is in fluid communication with a RO Pass 1 Permeate/Pass 2 Feed Tank 524a. The high-pressure RO pressure vessel and membrane module 520 is configured to provide a product solution to the RO Pass 1 Permeate/Pass 2 Feed Tank 524a. The high-pressure RO pressure vessel and membrane module 520 is in fluid communication with a RO Pass 2 Permeate/Pass 3 Feed Tank 524b. The high-pressure RO pressure vessel and membrane module 520 is configured to provide a product solution to the RO Pass 2 Permeate/Pass 3 Feed Tank 524b. The high-pressure RO pressure vessel and membrane module 520 is in fluid communication with a Pass 3 Product Water to Water Processor Assembly 526. The high-pressure RO pressure vessel and membrane module 520 is configured to provide a product solution to the Pass 3 Product Water to Water Processor Assembly 526.

The RO Pass 1 Permeate/Pass 2 Feed Tank 524a and the RO Pass 2 Permeate/Pass 3 Feed Tank 524b are in fluid communication with each other and/or the Pass 3 Product Water to Water Processor Assembly 526. The RO Pass 1 Permeate/Pass 2 Feed Tank 524a and the RO Pass 2 Permeate/Pass 3 Feed Tank 524b are configured to provide a purified product solution to each other and/or the Pass 3 Product Water to Water Processor Assembly 526. The RO Pass 1 Permeate/Pass 2 Feed Tank 524a and the RO Pass 2 Permeate/Pass 3 Feed Tank 524b are in fluid communication with the high-pressure RO pressure vessel and membrane module 520. The RO Pass 1 Permeate/Pass 2 Feed Tank 524a and the RO Pass 2 Permeate/Pass 3 Feed Tank 524b are configured to provide the RO permeate to the high-pressure RO pressure vessel and membrane module 520 through the cartridge filter 516 and the high pressure reverse osmosis feed pump 518.

Wastewater purification system including a break tank and a urine brine to brine processor assembly, such as system 500 of FIG. 5, may enable the forward osmosis process to be performed relatively quickly in order to form a supersaturated byproduct solution, which can be advantageously processed prior to or prior to substantial precipitation of solutes. As the reverse osmosis system may operate at a slower rate relative to the forward osmosis apparatus, decoupling the systems can ensure the throughput of the forward osmosis apparatus is not limited by the purification apparatus. Therefore, the forward osmosis apparatus can process the wastewater feed at a faster rate, thereby allowing for the formation of supersaturated solutions. Faster wastewater processing time in the forward osmosis apparatus may achieve water recoveries at or beyond supersaturation and improve the rejection of dissolved salts and organics. In addition, processing of such supersaturated solutions improves efficiencies and allows for a streamlined system relative to systems and methods that allow for the precipitation of solutes. As such, by allowing for faster wastewater processing times, embodiments of the present disclosure can achieve higher water recoveries relative to conventional processes. For example, in some embodiments, such wastewater purification systems may result in water recovery rates of, of about, of at least, or of at least about 90%, which is about 3% higher than rates reported by NASA for current wastewater purification systems.

Forward osmosis (FO) apparatuses, such as those described in any one of FIGS. 2-5, are configured to intake a wastewater feed source and draw solution, extract water from the wastewater feed source into the draw solution through a membrane, and form a byproduct and a processed draw solution (for example, a spent draw solution, a diluted draw solution). In some embodiments, the byproduct is a supersaturated byproduct solution. In some embodiments, the FO apparatus is a high-pressure FO apparatus, a hollow fiber membrane FO apparatus, a flat sheet membrane FO apparatus, a polyamide and cellulose triacetate FO apparatus, a counter-current flow FO apparatus, a co-current flows FO apparatus, or a combination thereof. In some embodiments, the wastewater the FO apparatus is configured to process includes urine, pretreated urine, urine brine, and combinations thereof. In some embodiments, the FO apparatus is configured to process other types of water streams and liquid streams.

In some embodiments, a wastewater processor assembly is in fluid communication with the wastewater feed source. In some embodiments, the wastewater processor assembly is configured to provide the wastewater feed to the FO apparatus. In some embodiments, the wastewater processor assembly includes a wastewater pre-treatment apparatus (for example, a urine pre-treatment apparatus), a wastewater tank, and combinations thereof. In some embodiments, the wastewater tank is a wastewater holding tank, a pretreated urine wastewater tank, and combinations thereof. In some embodiments, a brine processor assembly is in fluid communication with the wastewater feed source. In some embodiments, the brine processor assembly is configured to provide the wastewater feed source to the FO apparatus. In some embodiments, the brine processor assembly includes a urine brine holding tank.

A break tank is configured to receive the processed draw solution and is in fluid communication with the FO apparatus. Once the break tank receives the processed draw solution, the processed draw solution received from the break tank is a stored draw solution. In some embodiments, the break tank is configured to receive make-up draw salts and is in fluid communication with a draw salt make-up tank.

A purification apparatus is in fluid communication with the break tank. The purification apparatus is configured to receive the stored draw solution from the break tank. In some embodiments, the purification apparatus is a reverse osmosis (RO) apparatus, a distillation purification apparatus, or combinations thereof. In some embodiments, the RO apparatus is a high-pressure RO apparatus. In some embodiments, the RO apparatus is configured to provide a product (for example, a product solution, permeate, recovered water product) to a RO permeate tank. In some embodiments, the RO apparatus is configured to provide the recycled draw solution (for example, return solution) back to the RO apparatus. In some embodiments, the purification apparatus includes a plurality of purification modules, for example a plurality of RO modules.

In some embodiments, the forward osmosis apparatus is configured to operate at a first processing rate and the purification apparatus is configured to operate at a second processing rate, wherein the first processing rate is greater than the second processing rate. In some embodiments, the ratio of the first processing rate and the second processing rate (that is, first processing rate: second processing rate) is, is about, is at least, or is at least about, 1:1, 1.1:1, 1.2:1, 1.3:1, 1.5:1, 2:1, 2.5:1, 3:1, 3.5:1, 4:1, 4.5:1, 5:1, 6:1, 7:1, 8:1, 9:1 or 10:1, or any range of values therebetween.

In some embodiments, a byproduct processing apparatus is in fluid communication with the FO apparatus. The byproduct processing apparatus is configured to receive the byproduct (for example, a supersaturated byproduct solution) from the FO apparatus. In some embodiments, the byproduct processing apparatus is configured to form a processed byproduct, byproduct solutes and/or byproduct precipitates from the byproduct solution.

### Decoupled Wastewater Purification Methods

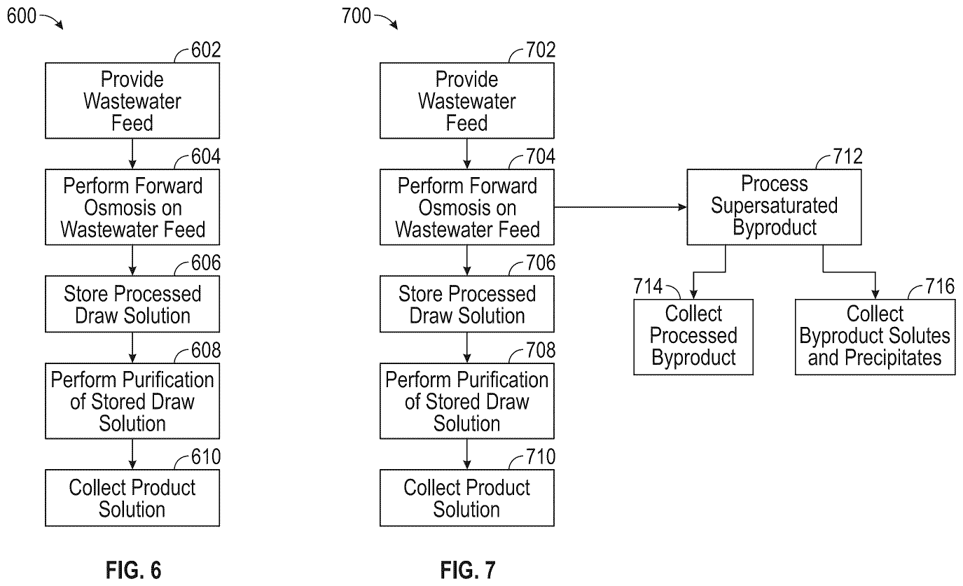

FIG. 6 is a flow chart of an example method 600 of purifying a wastewater feed including storing a processed draw solution according to an embodiment of the present disclosure. The method 600 can include features or methods that are substantially similar to features and methods described herein, for example such as those described in FIGS. 2-5 and 7 and descriptions thereof. The method 600 begins at step 602, where a wastewater feed is provided. The method 600 moves onto step 604, where forward osmosis is performed on the wastewater feed to form a processed draw solution. In some embodiments, the forward osmosis is performed in, in about, in at most, or in at most about 2 hours. The method 600 moves onto step 606, where the processed draw solution is stored. In some embodiments, the processed draw solution is stored for, for about, for at least, or for at least about, 0.5 hours. Subsequently in step 608, purification is performed on the stored draw solution to collect a product solution in step 610. In some embodiments, purification is performed in, in about, in at least, or in at least about, 5 hours. In some embodiments, the forward osmosis occurs at a first processing rate and performing purification occurs at a second processing rate, wherein the ratio of the first processing rate to the second processing rate is at least about 5:1. In some embodiments, the purification is a reverse osmosis purification. In some embodiments, the method 600 and/or steps of method 600 (for example, forward osmosis, purification) can be performed continuously, intermittently, batchwise and/or semi-batchwise. In some embodiments, performing forward osmosis is stopped prior to performing purification.

Wastewater purification methods that include storing the processed draw solution, such as method 600 of FIG. 6, decouple the forward osmosis process and the purification process, enabling variable operating modes and energy and/or cost savings. Furthermore, such wastewater purification methods including a processed draw solution storage may enable the forward osmosis process to be performed relatively quickly, and as the downstream purification may operate at a slower rate relative to the forward osmosis process, decoupling the methods can ensure the throughput of the forward osmosis is not limited by the purification. Therefore, such wastewater purification methods can process the wastewater feed at a faster rate, achieve water recoveries at or beyond supersaturation, improve the rejection of dissolved salts and organics (resulting in improved recovered water purity), and/or achieve higher water recoveries relative to conventional processes. For example, in some embodiments, such wastewater purification methods may result in water recovery rates of, of about, of at least, or of at least about 90%, which is about 3% higher than rates reported by NASA for current wastewater purification methods.

FIG. 7 is a flow chart of an example method 700 of purifying a wastewater feed including processing a supersaturated byproduct according to an embodiment of the present disclosure. The method 700 can include features or methods that are substantially similar to features and methods described herein, for example such as those described in FIGS. 2-6 and descriptions thereof. The method 700 begins at step 702, where a wastewater feed is provided. The method 700 moves onto step 704, where forward osmosis is performed on the wastewater feed to form a processed draw solution and a supersaturated byproduct. In some embodiments, the forward osmosis is performed in, in about, in at most, or in at most 2 hours. The method 700 moves onto step 706, where the processed draw solution is stored. In some embodiments, the processed draw solution is stored for, for about, for at least, or for at least about, 0.5 hours. Subsequently in step 708, purification is performed on the stored draw solution to collect a product solution in step 710. In some embodiments, purification is performed in, in about, in at least, or in at least about, 5 hours. In some embodiments, the forward osmosis occurs at a first processing rate and performing purification occurs at a second processing rate, wherein the ratio of the first processing rate to the second processing rate is at least about 5:1.

In step 712, the supersaturated byproduct is processed to form and collect a processed byproduct in step 714 and collect byproduct solutes and precipitates in step 716. In some embodiments, the byproduct solutes and precipitates collected in step 716 include or substantially include only solutes. In some embodiments, the byproduct solutes and precipitates collected in step 716 do not or do not substantially include precipitates. In some embodiments, the method 700 and/or steps of method 700 (for example, forward osmosis, purification, process supersaturated byproduct) can be performed continuously, intermittently, batchwise and/or semi-batchwise. In some embodiments, performing forward osmosis is stopped prior to performing purification.

Wastewater purification methods including storing the processed draw solution and forming a supersaturated byproduct, such as the method 700 of FIG. 7, may enable the forward osmosis process to be performed relatively quickly in order to form a supersaturated byproduct solution, which can be advantageously processed prior to or prior to substantial precipitation of solutes. As downstream purification may operate at a slower rate relative to forward osmosis, decoupling the method steps can ensure the throughput of the forward osmosis is not limited by the purification method. Therefore, the forward osmosis step can process the wastewater feed at a faster rate, thereby allowing for the formation of supersaturated solutions. Faster wastewater processing time in the forward osmosis step may allow for achieving water recoveries at or beyond supersaturation and improve the rejection of dissolved salts and organics. In addition, processing of such supersaturated solutions improves efficiencies and allows for a streamlined system relative to systems and methods that allow for the precipitation of solutes. As such, by allowing for faster wastewater processing times, embodiments of the present disclosure can achieve higher water recoveries relative to conventional processes. For example, in some embodiments, such wastewater purification methods may result in water recovery rates of, of about, of at least, or of at least about 90%, which is about 3% higher than rates reported by NASA for current wastewater purification methods.

Forward osmosis (FO) steps, such as those described in any one of FIGS. 6 and 7, process the wastewater feed using a draw solution to form a processed draw solution and a byproduct. Alternatively, the forward osmosis (FO) steps, such as those described in any one of FIGS. 6 and 7, process other types of water or liquid streams using a draw solution to form a processed draw solution and a byproduct. For example, forward (FO) steps can process water or liquid feeds from agricultural applications, such as but not limited to irrigation liquids and run-off liquids. As another example, forward (FO) steps can process water or liquid feeds from pharmaceutical applications, such as but not limited to pharmaceutical product liquids. In some embodiments, the wastewater feed may include urine, pretreated urine, urine brine, or combinations thereof. The draw solution includes salts to extract water from the wastewater feed through the FO process to form the processed draw solution (that is, a spent draw solution or a diluted draw solution). In some embodiments, the forward osmosis process is performed in, in about, in at most, or in at most about 0.5 hours, 1 hr, 1.5 hours, 2 hours, 2.5 hours, 3 hours, 3.5 hours, 4 hours, 4.5 hours, 5 hours, 5.5 hours, 6 hours, 7 hours, 8 hours, 9 hours or 10 hours, or any range of values therebetween.

The processed draw solution may be stored to form the stored draw solution. In some embodiments the stored draw solution is stored for, for about, for at least, or for at least about, 0.1 hours, 0.2 hours, 0.3 hours, 0.5 hours, 1 hours, 1.5 hours, 2 hours, 2.5 hours, 3 hours, 3.5 hours, 4 hours, 4.5 hours, 5 hours, 5.5 hours, 6 hours, 7 hours, 8 hours, 9 hours or 10 hours, or any range of values therebetween.

The stored draw solution is then purified to form a product (for example, a product solution). In some embodiments, purification includes reverse osmosis (RO) purification, distillation purification, or combinations thereof. In some embodiments, purification is performed in, in about, in at least, or in at least about, 3.5 hours, 4 hours, 4.5 hours, 5 hours, 5.5 hours, 6 hours, 7 hours, 8 hours, 9 hours, 10 hours, 12 hours, 15 hours, 18 hours, 20 hours, 22 hours or 24 hours, or any range of values therebetween. In some embodiments, the product includes a product solution, RO permeate, recovered water product, water, or combinations thereof. In some embodiments, the purification process forms a purification derivative. In some embodiments, the purification derivative is a recycled draw solution (for example, a return solution). In some embodiments, the purification derivative is returned to the FO processing step and/or the purification processing step. For example, the recycled draw solution may be returned to be FO processed and combined with the draw solution.

The byproduct formed from the FO process may be disposed of or further processed. In some embodiments, the byproduct is a supersaturated byproduct including a supersaturated solute. In some embodiments, the byproduct (for example, supersaturated byproduct) is processed to form a processed byproduct and byproduct solutes. In some embodiments, the byproduct (for example, supersaturated byproduct) is processed to form a processed byproduct, byproduct solutes, and byproduct precipitates. In some embodiments, the byproduct solute and/or byproduct precipitate includes a salt. In some embodiments, the byproduct solute and/or byproduct precipitate includes calcium sulfate, calcium phosphate, magnesium sulfate, magnesium phosphate, calcium carbonate, magnesium carbonate, ammonium nitrate, or combinations thereof. In some embodiments, the byproduct solute and/or byproduct precipitate includes calcium sulfate. In some embodiments, processing of the supersaturated byproduct occurs within an induction time of the supersaturated byproduct (for example, prior to the byproduct solutes precipitating or substantially precipitating out of solution). In some embodiments, processing of the supersaturated byproduct is performed in, in about, in at most, or in at most about, 0.1 min, 0.5 min, 1 min, 2 min, 3 min, 4 min, 5 min, 0.1 hours, 0.2 hours, 0.3 hours, 0.5 hours, 1 hours, 1.5 hours, 2 hours, or any range of values therebetween.

In some embodiments, performing forward osmosis occurs at a first processing rate and performing purification occurs at a second processing rate, wherein the first processing rate is greater than the second processing rate. In some embodiments, the ratio of the first processing rate to the second processing rate (that is, first processing rate: second processing rate) is, is about, is at least, or is at least about, 1:1, 1.1:1, 1.2:1, 1.3:1, 1.5:1, 2:1, 2.5:1, 3:1, 3.5:1, 4:1, 4.5:1, 5:1, 6:1, 7:1, 8:1, 9:1 or 10:1, or any range of values therebetween.

In some embodiments, the method includes a water recovery from the wastewater of, of about, of at least, or of at least about, 80 wt. %, 85 wt. %, 87 wt. %, 89 wt. %, 90 wt. %, 92 wt. %, 94 wt. %, 95 wt. %, 96 wt. %, 98 wt. %, 99 wt. % or 99.5 wt. %, or any range of values therebetween.

It will be understood that various steps of the methods described herein (for example, steps within each of method 600 and method 700) can be performed simultaneously or concurrently. It will also be understood that the methods and/or various steps of the methods can be performed continuously, while other steps are performed intermittently, batchwise and/or semi-batchwise. As such, the decoupled system may beneficially enable methods and/or various steps of the methods to be performed using a first subset of “online” system components, while a second, different subset of system components are offline, for example in a standby status or offline for cleaning. It will also be understood that the methods and/or various steps of the methods can be performed at constant pressure, and that the methods and/or various steps of the methods can be performed at constant flux or flow.

### Implementing Systems and Terminology

Implementations disclosed herein provide systems, methods, and devices for purifying a wastewater feed. Furthermore, the systems, methods, and devices described herein may be implemented for processing many other types of water streams and liquid streams, such as for agricultural and/or pharmaceutical applications. One skilled in the art will recognize that these embodiments may be implemented in hardware or a combination of hardware and software and/or firmware.

Throughout this disclosure, the term “fluid” encompasses both liquids and gases (for example, a wastewater feed), as well as liquids, gases, and suspended solids. It will also be understood that one or more pumps and/or filters (for example, cartridge filter) may be positioned between any systems or devices in fluid communication with each other, or utilized with any system or device configured to provide a material. It will be understood that apparatuses that are configured to receive, are configured to provide and/or are in fluid communication with another apparatus may be directly or indirectly so configured to in fluid communication.

The methods disclosed herein include one or more steps or actions for achieving the described method. The method steps and/or actions may be interchanged with one another without departing from the scope of the present disclosure. In other words, unless a specific order of steps or actions is required for proper operation of the method that is being described, the order and/or use of specific steps and/or actions may be modified without departing from the scope of the present disclosure.

With respect to the use of substantially any plural and/or singular terms herein, those having skill in the art can translate from the plural to the singular and/or from the singular to the plural as is appropriate to the context and/or application.

The above description discloses several methods and systems of the present disclosure. Embodiments of the present disclosure are susceptible to modifications in the methods and systems, as well as alterations in the fabrication methods and equipment. Such modifications will become apparent to those skilled in the art from a consideration of this disclosure or practice of the present disclosure. Consequently, it is to be understood that embodiments presented herein are by way of example and not by way of limitation. The intent of the above detailed description, although discussing exemplary embodiments, is to be construed to cover all modifications, alternatives, and equivalents of the embodiments as may fall within the spirit and scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures may be combined, interchanged or excluded from other embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, it is to be understood that not necessarily all such aspects, advantages, or features will be present in any particular embodiment of the present disclosure.

What is claimed is:

1. A wastewater purification system comprising:
a forward osmosis apparatus configured to receive a wastewater feed source and form a processed draw solution and a byproduct solution;
a break tank in fluid communication with and configured to receive the processed draw solution from the forward osmosis apparatus; and
a purification apparatus in fluid communication with and configured to receive the processed draw solution from the break tank and form a product solution and a return solution.

2. The system of claim 1, wherein the forward osmosis apparatus is configured to operate at a first processing rate and the purification apparatus is configured to operate at a second processing rate, wherein the first processing rate is greater than the second processing rate.

3. The system of claim 1, wherein the forward osmosis apparatus is configured to form a supersaturated byproduct solution.

4. The system of claim 1, further comprising a byproduct processing apparatus configured to receive the byproduct solution and form a processed byproduct and a byproduct solute.

5. The system of claim 4, wherein the byproduct processing apparatus is configured to form the processed byproduct and the byproduct solute within an induction time of the byproduct solution.

6. The system of claim 1, wherein the purification apparatus is a reverse osmosis purification apparatus.

7. The system of claim 1, wherein the forward osmosis apparatus is configured to receive the return solution from the purification apparatus.

8. The system of claim 1, further comprising a wastewater holding tank configured to provide the wastewater feed source to the forward osmosis apparatus.

9. A method of purifying wastewater, comprising:
performing forward osmosis on a wastewater feed source to form a processed draw solution and a byproduct solution;
storing the processed draw solution to form a stored draw solution; and
performing purification on the stored draw solution to form a product solution.

10. The method of claim 9, wherein the byproduct solution is a supersaturated byproduct comprising a supersaturated solute.

11. The method of claim 10, further comprising processing the supersaturated byproduct to form a processed byproduct and a byproduct solute.

12. The method of claim 11, wherein the byproduct solute comprises a salt selected from the group consisting of calcium sulfate, calcium phosphate, magnesium sulfate, magnesium phosphate, calcium carbonate, magnesium carbonate, ammonium nitrate, and combinations thereof.

13. The method of claim 11, wherein processing the supersaturated byproduct occurs within an induction time of the supersaturated byproduct.

14. The method of claim 9, wherein purification further comprises forming a recycled draw solution.

15. The method of claim 14, wherein performing forward osmosis comprises extracting water from the wastewater feed source into a draw solution, and wherein the draw solution comprises the recycled draw solution.

16. The method of claim 9, wherein purification comprises performing reverse osmosis.

17. The method of claim 9, wherein the stored draw solution is stored for at least 0.5 hours.

18. The method of claim 9, wherein forward osmosis is performed in at most 2 hours.

19. The method of claim 9, wherein purification is performed in at least 5 hours.

20. The method of claim 9, wherein the method is performed batchwise.

21. The method of claim 9, wherein forward osmosis is performed batchwise.

22. The method of claim 9, wherein purification is performed continuously.

23. The method of claim 9, wherein performing forward osmosis is stopped prior to performing purification.

24. The method of claim 9, wherein performing forward osmosis occurs at a first processing rate and performing purification occurs at a second processing rate, wherein the first processing rate is greater than the second processing rate.

25. The method of claim 24, wherein the ratio of the first processing rate to the second processing rate is at least about 5:1.

26. The method of claim 9, wherein the product solution comprises water.

27. The method of claim 9, wherein the wastewater feed source comprises urine.

28. The method of claim 27, wherein the method comprises a water recovery of at least about 90 wt. %.
